(19) United States
(12) Patent Application Publication
(10) Pub. No.: US 2004/0023642 A1
(43) Pub. Date: Feb. 5, 2004

(54) Wireless access point

(75) Inventor: Masao Tezuka, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 10/368,649

(22) Filed: Feb. 20, 2003

(30) Foreign Application Priority Data
Jul. 30, 2002 (JP) 2002-221623

(51) Int. Cl. H04M 3/16; H04M 1/68

(52) U.S. Cl. 455/411; 455/410

(57) ABSTRACT

A wireless access point capable of building up a communication network which, despite of its simple constitution, prevents eavesdropping of authentication data, facilitates the system management and effects the authentication within a short period of time. A central control unit at a wireless access point reads a bridge control program, an IEEE 802.1x control program and an authentication control program into a memory to execute them. Based upon the IEEE 802.1x control program and the authentication control program, the central control unit authenticates a wireless terminal on a wireless LAN in response to a request for access to a network on a wired LAN from the wireless terminal on the wireless LAN, and notifies a common key of WEP to the wireless terminal on the wireless LAN when the authentication is obtained. Thus, the wireless access point is furnished with an authentication server function which is installed on the wired LAN in a conventional network system.

### BACKGROUND OF THE INVENTION

1. Field of the Invention

This invention relates to a wireless access point for connecting wireless LANs together or for connecting a wireless LAN and a wired LAN together.

2. Description of the Related Art

In recent years, data communication by a wireless LAN (local area network) as represented by the standards of, for example, an IEEE 802.11 Series, has been widely employed. In the wireless LAN, a wireless network using electromagnetic waves is built up to transmit and receive the data among the PCs (personal computers) which are the wireless terminals or among the PCs and peripheral equipment such as printers.

In the IEEE 802.11b, for example, a wireless network can be built up by using electromagnetic waves of a 2.4 GHz band over a range of a distance of about 10 meters to about 100 meters at a data transfer rate of about 10 Mbps which is nearly equivalent to a low-speed wired LAN. In order to prevent the infiltration of noise, the IEEE 802.11b employs wireless communication based on the direct diffusion system which is one of the spectrum diffusion systems.

In recent years, further, a wireless LAN card in compliance with the IEEE 802.11a has been put into practice. This wireless LAN system realizes a transfer rate of a maximum of 54 Mbps by utilizing a 5 GHz band and by employing an OFDM modulation system (orthogonal frequency division multiplex modulation system).

The modes of communication may include an ad hoc system which directly exchanges the data among the transmitters and receives, and an infrastructure system which provides a wireless access point to exchange the data via the wireless access point. To realize the wireless LAN, a wireless LAN card and an adapter are mounted on the PCs and on the peripheral equipment, and wireless access point is set as required.

In recent years, further, an access control technology based upon the IEEE 802.1x has been employed as authentication technology at the time of connecting a wireless terminal on the wireless LAN to another wireless LAN or wired LAN. FIG. 3 illustrates conventional wireless access points for connecting a wireless LAN to a wired LAN and the peripheries thereof.

Referring to FIG. 3, a wireless access point 100 has a central control unit 102 comprising a microprocessor or the like for controlling various electronic circuits in the device. The central control unit 102 reads a bridge control program 106 and an IEEE 802.1x control program 108 stored in a storage unit into a memory 104 to execute them. Based upon the bridge control program 106, the central control unit 102 transmits a predetermined command and data to a wireless LAN interface unit 110 and to a wired LAN interface unit 112 to exchange the data among the terminals and resources (both of which are not shown) connected to the wireless LAN and the terminals (PCs and resources such as routers, printers, etc.)(not shown) connected to the wired LAN 114.

Based on the IEEE 802.1x control program 108, further, the central control unit 102 inquires the authentication of a wireless terminal on the wireless LAN to an authentication (Remote Authentication Dial-In User Service: RADIUS) server 120 installed on the wired LAN in response to a request for access to the reliable network 130 on the wired LAN 114 sent from the wireless terminal on the wireless LAN, and notifies a common key of WEP to the wireless terminal on the wireless LAN when the authentication is obtained.

Like the wireless access point 100, the authentication server 120, too, has a central control unit 122 comprising a microprocessor or the like for controlling various electronic circuits in the device. The central control unit 122 reads an authentication control program 126 stored in a storage unit into a memory 124 to execute it. Based on the authentication control program 126, the central control unit 122 sends a predetermined command and data to the wired LAN interface unit 128, and notifies the result of authentication of the wireless terminal on the wireless LAN to the wireless access point 100.

FIG. 4 illustrates an example in which a certificate issue server 140 is installed on the wired LAN 114 in the network system of FIG. 3. When an EAP-TLS system which is one of the authentication systems is used, a certificate issue server 140 is necessary for issuing a secrete key for authenticating the client and for issuing a public key (certificate). Unlike the password system, the authentication system effects the authentication in the form of an electronic certificate, and must distribute certificates to the clients and to the servers in advance.

Like the wireless access point 100, the certificate issue server 140, too, has a central control unit 142 comprising a microprocessor or the like for controlling various electronic circuits in the device. The central control unit 142 reads a certificate issue program 146 stored in a storage unit into a memory 144 to execute it. Based on the certificate issue program 146, the central control unit 142 sends a predetermined command or data to a wired LAN interface unit 148, and sends a certificate data of a wireless terminal on the wireless LAN to, for example, an IC card reading/writing device (not shown) on a reliable network 130. An IC card recording the certificate of a predetermined wireless terminal is prepared by the IC card reading/writing device.

In the conventional network system shown in FIG. 3 or 4 as described above, the authentication server 120 is provided on the wired LAN 114 to authenticate the wireless terminal on the wireless LAN making it possible to prevent unauthorized access to the network 130 to thereby improve reliability in the communication. Further, the certificate issue server 140 is provided on the wired LAN 114 to process secrete codes such as authentication data, thereby to prevent unauthorized access, to prevent eavesdropping or manipulation of authentication data to further improve the reliability of communication.

In the above conventional network system, however, the authentication server 120 and the certificate issue server 140 must be installed respectively on the wired LAN 114 to which the network 130 is connected, resulting in a complex system constitution.

Besides, a packet for authentication exchanged among the wireless access point 100, authentication server 120 and certificate issue server 140, flows on the wireless LAN and is likely to be eavesdropped. Further, since the packet for authentication flows on the wireless LAN and on the wired LAN 114 in the step of authentication, the time (response time) needed for the authentication greatly varies depending upon the traffic through the wireless LAN and the wired LAN 114.

### SUMMARY OF THE INVENTION

This invention, therefore, provides a wireless access point capable of building up a communication network preventing eavesdropping of authentication data, facilitating the management of the system and requiring a short authentication time despite of its simple constitution.

The above object of the invention is achieved by a wireless access point for connecting a wireless LAN and a wired LAN together which comprises a bridge control program for enabling the transmission and reception of data between the wireless LAN and the wired LAN, and an access control program; an authentication control program for authenticating a wireless terminal in response to a request for access to the wired LAN from the wireless terminal on the wireless LAN; an authentication data storage unit storing the authentication data for authenticating the wireless terminal; and a central control unit for executing the programs.

The invention is further concerned with a wireless access point which comprises a certificate issue program for issuing a certificate to the wireless terminal.

The invention is further concerned with a wireless access point in which the access control program is based upon an IEEE 802.1x control program.

The invention is further concerned with a wireless access point in which the authentication control program is Remote Authentication Dial-In User Service control program.

The above object of the invention is further achieved by a wireless LAN system which comprises a wireless access point for connecting a wireless LAN and a wired LAN together; a wired terminal connected to a wired LAN interface unit possessed by the wireless access point; and a wireless terminal for transmitting and receiving the data through a wireless LAN interface possessed by the wireless access point; wherein the wireless access point comprises a bridge control program for enabling the transmission and reception of data between the wireless LAN and the wired LAN, and an access control program; an authentication control program for authenticating the wireless terminal in response to a request for access to the wired LAN from the wireless terminal on the wireless LAN; an authentication data storage unit storing the authentication data for authenticating the wireless terminal; and a central control unit for executing the programs.

The invention is further concerned with a wireless LAN system in which the wireless access point further comprises a certificate issue program for issuing a certificate to the wireless terminal.

The invention is further concerned with a wireless LAN system in which the access control program is based upon an IEEE 802.1x control program.

The invention is further concerned with a wireless LAN system in which the wireless access point further comprises a certificate issue program for issuing a certificate to the wireless terminal; and the access control program is based upon an IEEE 802.1x control program.

The invention is further concerned with a wireless LAN system in which the authentication control program is Remote Authentication Dial-In User Service control program.

The invention is further concerned with a wireless LAN system in which the wireless access point further comprises a certificate issue program for issuing a certificate to the wireless terminal; and the authentication control program is Remote Authentication Dial-In User Service control program.

The invention is further concerned with a wireless LAN system in which the access control program is based upon an IEEE 802.1x control program; and the authentication control program is Remote Authentication Dial-In User Service control program.

The invention is further concerned with a wireless LAN system in which the wireless access point further comprises a certificate issue program for issuing a certificate to the wireless terminal; the access control program is based upon an IEEE 802.1x control program; and the authentication control program is Remote Authentication Dial-In User Service control program.

### BRIEF DESCRIPTION OF THE DRAWINGS

FIG. 1 is a block diagram schematically illustrating the constitution of a wireless access point according to an embodiment of the invention;

FIG. 2 is a block diagram schematically illustrating the constitution of another wireless access point according to the embodiment of the invention;

FIG. 3 is a block diagram schematically illustrating the constitution of a conventional wireless access point; and

FIG. 4 is a block diagram schematically illustrating the constitution of another conventional wireless access point.

### DETAILED DESCRIPTION OF THE PREFERRED EMBODIMENT

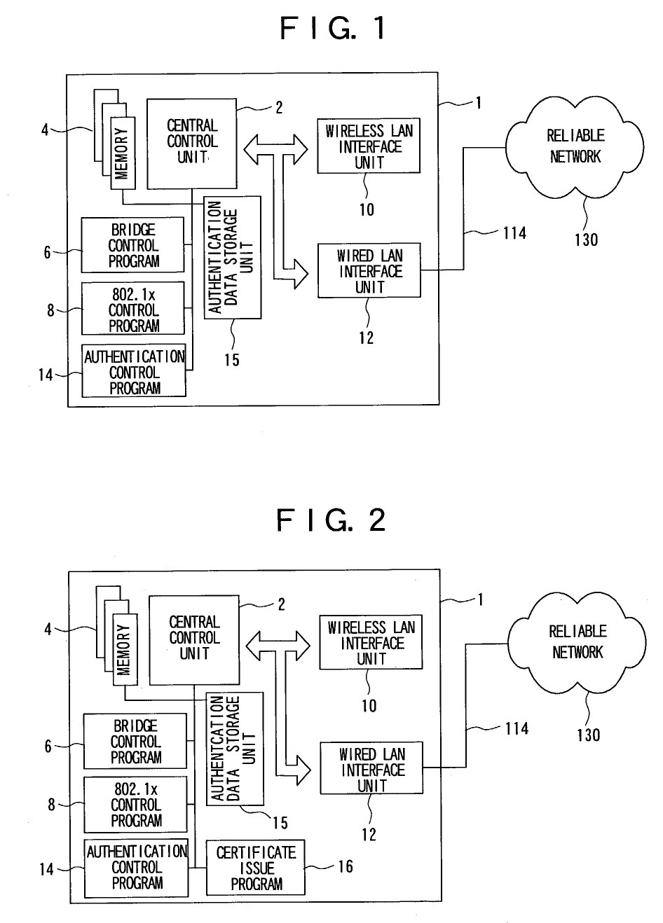

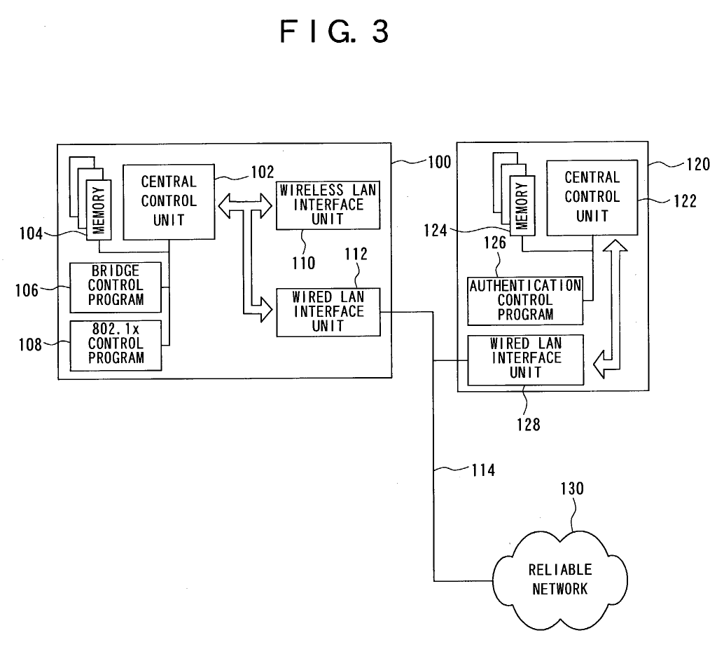

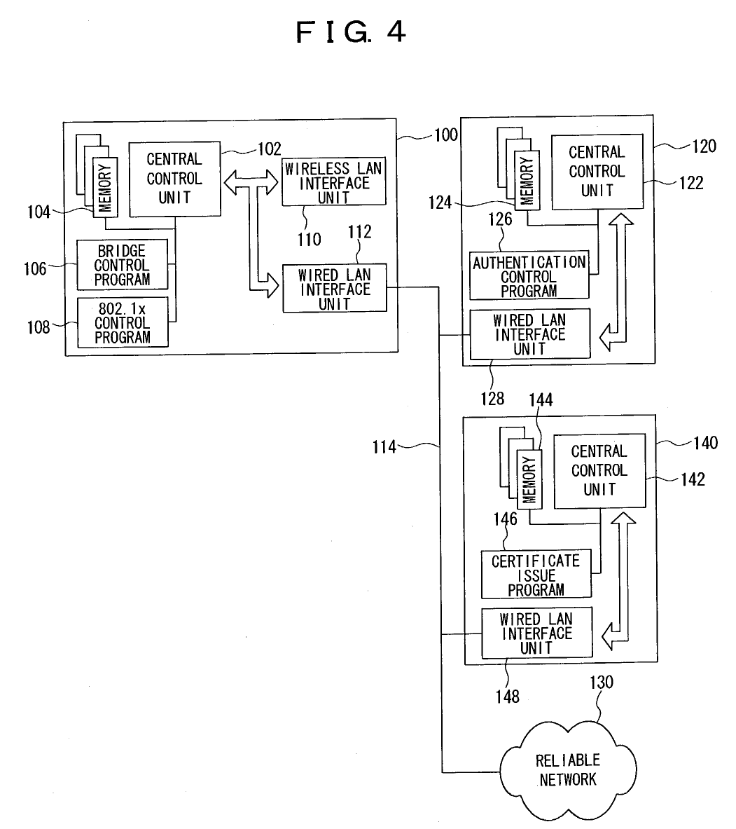

A wireless access point according to an embodiment of the invention will now be described with reference to FIGS. 1 and 2. First, a schematic constitution of the wireless access point according to the embodiment will be described with reference to FIG. 1. This embodiment has a feature in that the wireless access point is furnished with a user certificate issue function and an authentication function.

FIG. 1 illustrates the wireless access point according to the embodiment and the peripheries thereof. Referring to FIG. 1, the wireless access point 1 has a central control unit 2 comprising a microprocessor or the like for controlling various electronic circuits in the device. The central control unit 2 reads abridge control program 6, an IEEE 802.1x control program 8 as well as an authentication control program 14 stored in a storage unit into a main storage (memory) 4 to execute them. The authentication control program 14 is Remote Authentication Dial-In User Service control program. Based on the bridge control program 6, the central control unit 2 sends a predetermined command and data to a wireless LAN interface unit 10 and to a wired LAN interface unit 12, enabling the data to be transmitted and received among the terminals and resources connected to the wireless LAN and the terminals and resources connected to the wired LAN 114.

The central control unit 2 makes a reference to the authentication data in the authentication data storage unit 15, authenticates a wireless terminal on the wireless LAN in response to a request for access to a reliable network 130 on the wired LAN 114 from, for example, a wireless terminal (personal computer) on the wireless LAN based on the IEEE 802.1x control program 8 and the authentication control program 14, and notifies a common key of WEP to the wireless terminal on the wireless LAN when the authentication is obtained. The authentication data storage unit 15 stores, for example, user data, user name, password, authentication condition, IP address, etc. As described above, the wireless access point 1 according to the embodiment is furnished with the function of the authentication server 120 installed on the wired LAN 114 in the conventional network system.

Upon receipt of a request for authentication from a wireless terminal on the wireless LAN through an “uncontrolled port” of the wireless LAN, the IEEE 802.1x control program 8 transmits the request to the authentication control program 14 and transmits a response of authentication to the wireless terminal on the wireless LAN. Simultaneously with this response of authentication, the authentication control program transmits an authentication permission and a common key for the encryption to the wireless terminal. The wireless access point 1, too, sets a common key for the communication with the wireless terminal. After the authentication, the communication with the wireless terminal is enciphered with a common key distributed as a “controlled port”.

The communication is deciphered with the common key when the enciphered packet is transmitted from the controlled port (wireless terminal) to the wired side, and is enciphered with the common key when the packet is transmitted from the wired LAN 114 to the controlled port (wireless terminal). Here, the uncontrolled port is a part where the packet for authentication that has not been enciphered passes through, and the controlled port is a part where the packet enciphered with the common key passes through. Both of these parts exist in the wireless access point 1.

FIG. 2 illustrates an example in which a certificate issue program 16 is further stored in the wireless access point 1 in the network system shown in FIG. 1. When an EAP-TLS system which is one of the authentication systems is used, a certificate issue server function is necessary for issuing a secret key for authenticating the client and a public key (certificate).

The central control unit 2 reads the certificate issue program 16 stored in the storage unit into the main storage 4 to execute it. Based on the certificate issue program 16, the central control unit 2 forms a certificate for the server in the wireless access point 1. The certificate for the client that is formed is sent to, for example, an IC card reading/writing device (not shown) on the reliable network 130 on the wired LAN 114 through the wired LAN interface unit 12. The IC card reading/writing device prepares an IC card recording the certificate for the client for the predetermined wireless terminal. Thus, the certificate for the client is issued limitedly within the reliable network 130 on the side of the wired LAN 114 to further improve the reliability of communication.

In the network system equipped with the wireless access point shown in FIG. 1 or 2 as described above, a wireless terminal on the wireless LAN can be authenticated at the wireless access point 1, eliminating the need of providing the authentication server 120 or the certificate issue server 140 on the wired LAN 114. Unlike the conventional network system, therefore, there is obtained a simple system constitution free of a bother of installing the authentication server 120 and the certificate issue server 140 on the wired LAN 114 to which the network 130 is connected.

The packet for authentication does not flow onto the wireless LAN and is not likely to be eavesdropped. Besides, the packet for authentication does not flow on the wireless LAN or on the wired LAN 114 in the step of authentication. Accordingly, the authentication is realized within a short period of time without at all affected by traffic through the wireless LAN and the wired LAN 114.

Besides, the certificate for the server is issued in the wireless access point 1 having an authentication server function and is saved in the wireless access point 1, facilitating the management thereof.

As described above, this embodiment realizes the wireless access point capable of building up a communication network which, despite of its simple constitution, prevents eavesdropping of authentication data, facilitates the system management and effects the authentication within a short period of time.

According to this invention as described above, there is constituted a communication network based on a simple system constitution which can be easily managed, executing the authentication within a shortened period of time.

What is claimed is:

1. A wireless access point for connecting a wireless LAN and a wired LAN together, comprising:
a bridge control program for enabling the transmission and reception of data between the wireless LAN and the wired LAN, and an access control program;
an authentication control program for authenticating a wireless terminal in response to a request for access to the wired LAN from the wireless terminal on the wireless LAN;
an authentication data storage unit storing the authentication data for authenticating the wireless terminal; and
a central control unit for executing the programs.

2. A wireless access point according to claim 1, further comprising a certificate issue program for issuing a certificate to the wireless terminal.

3. A wireless access point according to claim 1, wherein the access control program is based upon an IEEE 802.1x control program.

4. A wireless access point according to claim 1, wherein the authentication control program is Remote Authentication Dial-In User Service control program.

5. A wireless LAN system comprising:
a wireless access point for connecting a wireless LAN and a wired LAN together;
a wired terminal connected to a wired LAN interface unit possessed by the wireless access point; and
a wireless terminal for transmitting and receiving the data through a wireless LAN interface possessed by the wireless access point;
wherein the wireless access point comprises:
a bridge control program for enabling the transmission and reception of data between the wireless LAN and the wired LAN, and an access control program;
an authentication control program for authenticating the wireless terminal in response to a request for access to the wired LAN from the wireless terminal on the wireless LAN;
an authentication data storage unit storing the authentication data for authenticating the wireless terminal; and
a central control unit for executing the programs.

6. A wireless LAN system according to claim 5, wherein the wireless access point further comprises a certificate issue program for issuing a certificate to the wireless terminal.

7. A wireless LAN system according to claim 5, wherein the access control program is based upon an IEEE 802.1x control program.

8. A wireless LAN system according to claim 5, wherein the wireless access point further comprises a certificate issue program for issuing a certificate to the wireless terminal; and
the access control program is based upon an IEEE 802.1x control program.

9. A wireless LAN system according to claim 5, wherein the authentication control program is Remote Authentication Dial-In User Service control program.

10. A wireless LAN system according to claim 5, wherein the wireless access point further comprises a certificate issue program for issuing a certificate to the wireless terminal; and
the authentication control program is Remote Authentication Dial-In User Service control program.

11. A wireless LAN system according to claim 5, wherein the access control program is based upon an IEEE 802.1x control program; and
the authentication control program is Remote Authentication Dial-In User Service control program.

12. A wireless LAN system according to claim 5, wherein the wireless access point further comprises a certificate issue program for issuing a certificate to the wireless terminal;
the access control program is based upon an IEEE 802.1x control program; and
the authentication control program is Remote Authentication Dial-In User Service control program.
